(19) United States
(12) Patent Application Publication
(10) Pub. No.: US 2019/0217923 A1
(43) Pub. Date: Jul. 18, 2019

(54) DIPHASE STAINLESS STEEL CHEMICAL VESSEL BALLAST CABIN BULKHEAD AND PROCESSING METHOD

(71) Applicant: HK XUYANG TECHNOLOGY LIMITED, HONG KONG (HK)

(72) Inventor: XU YANG, HONG KONG (HK)

(21) Appl. No.: 15/870,871

(22) Filed: Jan. 13, 2018

(51) Int. Cl. B63B 11/04; B23K 31/02; C21D 7/06; C23C 22/06

(52) U.S. Cl. CPC B63B 11/04; B23K 31/02; B23K 2203/05; C23C 22/06; C21D 7/06

(57) ABSTRACT

A diphase stainless steel chemical vessel ballast cabin bulkhead includes a front cover, a rear cover and reinforced string boards. The front cover and the rear cover are distributed parallel with each other. The front cover and the rear cover are inter-connected by the reinforced string boards. The reinforced string board includes a deformation groove and connection plates, and the connection plates are distributed on two sides of the deformation groove symmetrically with respect to a central line of the deformation groove. The reinforced string boards are evenly distributed between the front cover and the rear cover; the reinforced string boards and an axis of the front cover and the rear cover are distributed parallel. Adjacent reinforced string boards are mutually connected. A thickness of the front cover is at least one time thicker than that of the rear cover. The processing method thereof includes three steps.

### FIELD OF THE DISCLOSURE

The disclosure relates to a marine sheet material and a manufacturing process thereof, and more particularly to a diphase stainless steel chemical vessel ballast cabin bulkhead and a processing method.

### BACKGROUND

Along with the rapid development of the shipping business, shipping transportation is one of the most frequently used logistics transportation manners at present, and the amount of ships in use is considerable. In order to enhance the safety of ships in use and reduce the cost in operation, materials used for ship bodies and each cabins are innovated and modified constantly. The ballast cabin is a critical cabin for safely driving ships, as well as storing transported sheet materials, and the structural stability thereof directly affects the safety and reliability in usage of the entire ship. As the ballast cabin requires to be stored with large amounts of materials such as goods, water, fuels and the like, the ballast cabin needs to bear huge loads throughout. The bulkhead can be severally damaged due to the impact, friction, corrosion or the like, especially when the ballast cabin stores contaminative or corrosive chemicals, the phenomena are more severe. Meanwhile, as structures of bulkheads of conventional ballast cabins are simple alloy sheets with reinforced string boards, the bearing ability thereof is excellent, but the toughness, anti-impact property, anti-corrosion property and abrasion resistance are limited, which lead to the frequent fix and maintenance of the ballast cabin. Meanwhile, in order to enhance the structural property of the bulkhead of the ballast cabin, as well as increasing the thickness of the bulkhead, which further leads to raise the weight of the bulkhead, and resulting in increasing costs of building and driving the ship. Aiming at the situation, a novel structure of the bulkhead of the ballast cabin and a manufacturing process are urgent to be developed to meet the requirement in practical usage.

### SUMMARY

An objective of the disclosure is to provide a diphase stainless steel chemical vessel ballast cabin bulkhead and a processing method thereof.

In order to fulfill the objective above, the disclosure provides following technical solutions.

A diphase stainless steel chemical vessel ballast cabin bulkhead includes a front cover, a rear cover and reinforced string boards. The front cover and the rear cover are distributed parallel with each other. The front cover and the rear cover are inter-connected by the reinforced string boards. The reinforced string board includes a deformation groove and connection plates, and the connection plates are distributed on two sides of the deformation groove symmetrically with respect to a central line of the deformation groove. The reinforced string boards are evenly distributed between the front cover and the rear cover; the reinforced string boards and an axis of the front cover and the rear cover are distributed parallel. The reinforced string boards that are adjacent are mutually connected. A thickness of the front cover is at least one time thicker than that of the rear cover.

Furthermore, a cross section of the deformation groove is a rectangle or an isosceles trapezium.

Furthermore, a width of the connection plates is no wider than a half of that of the deformation groove.

Furthermore, the reinforced string boards are evenly defined with unloading holes.

Furthermore, granular rigid fillers are disposed in the deformation groove.

Furthermore, the granular rigid fillers are rigid ceramic grains.

A processing method of a diphase stainless steel chemical vessel ballast cabin bulkhead includes following steps.

A first step is pre-connection. The front cover, the rear cover and the reinforced string boards are positioned and mounted; then the front cover, the rear cover and the reinforced string boards are connected by spot welding.

A second step is high temperature fusion welding. The pre-connected front cover, the rear cover and the reinforced string boards are simultaneously heated to 900° C.-1200° C. for high temperature fusion welding for at least one minutes; the heating rate is no slower than 50° C. per minute. Outer surfaces of the front cover and the rear cover are further loaded with a pressure that is no less than 300 kilograms per square meter in average during fusion welding. After high temperature fusion welding, the temperature is cooled down at room temperature, and the tempering modification is employed when the temperature is cooled down to 200° C.-500° C., subsequently cooling down to the room temperature. The granular rigid fillers are filled in the deformation groove according the requirement in usage.

A third step is superficial enforcement processing. Outer surfaces and inner surfaces of the sheet materials after fusion welding first are cleansed by acid, subsequently by high pressure water. After cleansing, the outer surfaces of the front cover, the rear cover and the reinforced string boards are processed by stress peening; the inner surfaces and the outer surfaces of the front cover, the rear cover and the reinforced string boards finally are passivated by acid.

Furthermore, in the second step, during the high temperature fusion welding, the front cover, the rear cover and the reinforced string boards are processed in high pressure argon.

Furthermore, during the stress peening in the third step, cast steel grits whose hardness is no less than 55HRC are adopted.

Furthermore, before passivating the front cover, the rear cover and the reinforced string boards in the third step, almandine grits are adopted to purify the surfaces of the front cover, the rear cover and the reinforced string boards.

The manufacturing process of the disclosure is simple. With the same volume, compared with the conventional vessel ballast cabin bulkhead sheet structure, the structure is strengthened, light weighted, highly bearing, excellent in toughness, impact resistance, corrosion resistance and abrasion resistance, which can effectively improve the bearing ability and anti-impact ability of the ballast cabin. The service life of the ballast cabin can be effectively enhanced to reduce the maintenance fee for achieving the objective of enhancing the safety of vessels and reducing the cost of maintenance.

### BRIEF DESCRIPTION OF THE DRAWINGS

In order to more clearly explain technical solutions in the disclosure or prior art, the drawings required in description of the embodiments or the prior art will be briefly introduced. Apparently, the described drawings below purely are some embodiments of the disclosure, and a person skilled in the art can obtain other drawings according to these drawings without any inventive work.

FIG. 1 is a schematic view of a structure of the disclosure;

FIG. 2 is a flowchart of a process of the disclosure.

### DETAILED DESCRIPTION OF PREFERRED EMBODIMENTS

Embodiments of the disclosure will be clearly illustrated with reference to the accompanying drawings. Apparently, the described embodiments herein are some but not all of the embodiments. Based on the embodiments of the disclosure, all the other embodiments obtained by a person skilled in the art without any creativity belong to the protective scope of the disclosure.

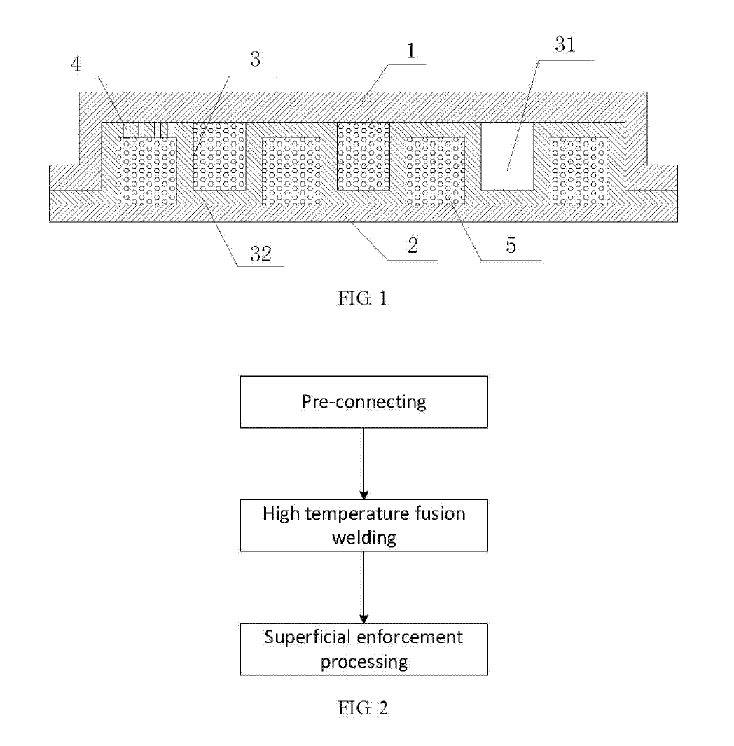

A diphase stainless steel chemical vessel ballast cabin bulkhead as shown in FIG. 1 includes a front cover 1, a rear cover 2 and reinforced string boards 3. The front cover 1 and the rear cover 2 are distributed parallel. The front cover 1 and the rear cover 2 are inter-connected by the reinforced string boards 3. The reinforced string boards 3 include deformation grooves 31 and connection plates 32; the connection plates 32 are distributed on two sides of the deformation groove 31 symmetrically with respect to a central line of the deformation groove 31. The reinforced string boards 3 are evenly distributed between the front cover 1 and the rear cover 2; the reinforced string boards 3 and the axis of the front cover 1 and the rear cover 2 are distributed parallel. Adjacent reinforced string boards 3 are mutually connected. A thickness of the front cover 1 is at least one time greater than that of the rear cover 2.

In the embodiment, cross sections of the deformation grooves 31 are rectangles or isosceles trapeziums.

In the embodiment, the width of the connection plate 32 is no larger than a half of the width of the deformation groove 31.

In the embodiment, the reinforced string boards 3 further are evenly defined with unloading holes 4.

In the embodiment, granular rigid fillers 5 are further disposed in the deformation grooves 31.

In the embodiment, the granular rigid fillers 5 are rigid ceramic grains.

FIG. 2 shows a processing method of a diphase stainless steel chemical vessel ballast cabin bulkhead

### Embodiment 1

A processing method of a diphase stainless steel chemical vessel ballast cabin bulkhead includes following steps.

A first step is pre-connection. The front cover, the rear cover and the reinforced string boards are positioned and assembled; then the front cover, the rear cover and the reinforced string boards are connected by spot welding. Wiped joints are distributed as a rectangular array. Distances between adjacent wiped joints are larger than ⅕ of the minimal edge length of the front cover and the rear cover.

A second step is high temperature fusion welding. The pre-connected front cover, the rear cover and the reinforced string boards are simultaneously heated to 1000° C. for high temperature fusion welding for at least three minutes; the heating rate is 100° C. per minute. Outer surfaces of the front cover and the rear cover are further loaded with a pressure of 500 kilograms per square meter in average during fusion welding. After high temperature fusion welding, the temperature is cooled down at room temperature, and the tempering modification is employed when the temperature is cooled down to 400° C., subsequently cooling down to the room temperature. The granular rigid fillers can be filled in the deformation grooves according the requirement in usage.

A third step is superficial enforcement processing. Outer surfaces and inner surfaces of the sheet materials after fusion welding first are cleansed by acid, subsequently by high pressure water. After cleansing, the outer surfaces of the sheet materials are processed by stress peening; the inner surfaces and the outer surfaces of the sheet materials finally are processed by acid passivating.

In the embodiment, in the second step, during the high temperature fusion welding, the front cover, the rear cover and the reinforced string boards are processed under high pressure argon; the pressure of argon is 1-3 times higher than the standard atmospheric pressure.

In the embodiment, during the stress peening in the third step, cast steel grits whose hardness is 80 HRC are adopted.

In the embodiment, before passivating the sheet materials in the third step, almandine grits are further adopted to purify the surfaces of the sheet materials.

### Embodiment 2

A processing method of a diphase stainless steel chemical vessel ballast cabin bulkhead includes following steps.

A first step is pre-connection. The front cover, the rear cover and the reinforced string boards are positioned and assembled; then the front cover, the rear cover and the reinforced string boards are connected by spot welding.

Wiped joints are distributed as a rectangular array. Distances between adjacent wiped joints are larger than ⅙ of the minimal edge length of the front cover and the rear cover.

A second step is high temperature fusion welding. The pre-connected front cover, the rear cover and the reinforced string boards are simultaneously heated to 1100° C. for high temperature fusion welding for at least two minutes; the heating rate is 50° C. per minute. Outer surfaces of the front cover and the rear cover are further loaded with a pressure of 300 kilograms per square meter in average during fusion welding. After high temperature fusion welding, the temperature is cooled down at room temperature, and the tempering modification is employed when the temperature is cooled down to 300° C., subsequently cooling down to the room temperature. During welding, inner surfaces at edges of the front cover and the rear cover both are connected with the connection plates of the reinforced string boards by welding.

A third step is superficial enforcement processing. Outer surfaces and inner surfaces of the sheet materials after fusion welding first are cleansed by acid, subsequently by high pressure water. After cleansing, the outer surfaces of the sheet materials are processed by stress peening; the inner surfaces and the outer surfaces of the sheet materials finally are processed by acid passivating.

In the embodiment, in the second step, during the high temperature fusion welding, the front cover, the rear cover and the reinforced string boards are processed under high pressure argon; the pressure of argon is 1-2 times higher than the standard atmospheric pressure.

In the embodiment, during the stress peening in the third step, cast steel grits whose hardness is 60 HRC are adopted.

In the embodiment, before passivating the sheet materials in the third step, almandine grits are further adopted to purify the surfaces of the sheet materials.

The manufacturing process of the disclosure is simple. With the same volume, compared with the conventional vessel ballast cabin bulkhead sheet structure, the structure is strengthened, light weighted, highly bearing, excellent in toughness, impact resistance, corrosion resistance and abrasion resistance, which can effectively improve the bearing ability and anti-impact ability of the ballast cabin. The service life of the ballast cabin can be effectively enhanced to reduce the maintenance fee for achieving the objective of enhancing the safety of vessels and reducing the cost of maintenance.

The description above purely shows concrete embodiments of the disclosure, but the protective scope of the disclosure is not limited as such. A person skilled in the art should understand that the disclosure will not be restricted to the aforementioned embodiments. The description in the embodiments described above and the specification purely for illustrating the principle of the disclosure. The disclosure can be modified and improved without excluding from the spirit and the scope of the disclosure. The modification and improvement should be included in the scope of the disclosure claimed to be protected. The scope of the disclosure claimed to be protected is defined by the attached claims and the counterparts.

What is claimed is:

1. A diphase stainless steel chemical vessel ballast cabin bulkhead, wherein the diphase stainless steel chemical vessel ballast cabin bulkhead comprises a front cover, a rear cover and reinforced string boards, the front cover and the rear cover are distributed parallel with each other, the front cover and the rear cover are inter-connected by the reinforced string boards, the reinforced string board comprises a deformation groove and connection plates, the connection plates are distributed on two sides of the deformation groove symmetrically with respect to a central line of the deformation groove, the reinforced string boards are evenly distributed between the front cover and the rear cover, the reinforced string boards and an axis of the front cover and the rear cover are distributed parallel, the reinforced string boards that are adjacent are mutually connected, a thickness of the front cover is at least one time thicker than that of the rear cover, a width of the connection plates is no wider than a half of that of the deformation groove, the reinforced string boards are evenly defined with unloading holes, granular rigid fillers are disposed in the deformation groove.

2. The diphase stainless steel chemical vessel ballast cabin bulkhead according to claim 1, wherein a cross section of the deformation groove is a rectangle or an isosceles trapezium.

3. The diphase stainless steel chemical vessel ballast cabin bulkhead according to claim 1, wherein the granular rigid fillers are rigid ceramic grains.

4. A processing method of a diphase stainless steel chemical vessel ballast cabin bulkhead, wherein the processing method of a diphase stainless steel chemical vessel ballast cabin bulkhead comprises following steps:
a first step: pre-connecting, positioning and mounting a front cover, a rear cover and reinforced string boards, connecting the front cover, the rear cover and the reinforced string boards by spot welding;
a second step: fusion welding, heating the front cover, the rear cover and the reinforced string boards after pre-connecting simultaneously to 900° C.-1200° C. for fusion welding for at least one minute, a heating rate is no slower than 50° C. per minute, outer surfaces of the front cover and the rear cover are loaded with a pressure that is no less than 300 kilograms per square meter in average during fusion welding, after fusion welding, the front cover, the rear cover and the reinforced string boards are cooled down at a room temperature, and processed by a tempering modification at 200° C.-500° C., subsequently down to the room temperature, filling granular rigid fillers in a deformation groove according to requirements;
a third step: superficial enforcement processing, first cleansing the outer surfaces and inner surfaces of the front cover, the rear cover and the reinforced string boards after fusion welding by acid, then cleansing by water, after cleansing, processing the outer surfaces of the front cover, the rear cover and the reinforced string boards by stress peening, finally passivating the inner surfaces and the outer surfaces of the front cover, the rear cover and the reinforced string boards by the acid.

5. The processing method of a diphase stainless steel chemical vessel ballast cabin bulkhead according to claim 4, wherein in the second step, during fusion welding, the front cover, the rear cover and the reinforced string boards are processed in argon.

6. The processing method of a diphase stainless steel chemical vessel ballast cabin bulkhead according to claim 4, wherein during stress peening in the third step, cast steel grits whose hardness is no less than 55HRC are adopted.

7. The processing method of a diphase stainless steel chemical vessel ballast cabin bulkhead according to claim 4, wherein before passivating the inner surfaces and the outer surfaces of the front cover, the rear cover and the reinforced string boards by the acid in the third step, almandine grits are adopted to purify surfaces of the front cover, the rear cover and the reinforced string boards.
